(19) United States
(12) Patent Application Publication
(10) Pub. No.: US 2017/0036295 A1
(43) Pub. Date: Feb. 9, 2017

(54) TIG Glide

(71) Applicant: Derick Alan Clifton, Lawrenceburg, KY (US)

(72) Inventor: Derick Alan Clifton, Lawrenceburg, KY (US)

(21) Appl. No.: 15/226,551

(22) Filed: Aug. 2, 2016

Related U.S. Application Data
(60) Provisional application No. 62/200,122, filed on Aug. 3, 2015.

(51) Int. Cl. B23K 9/32; B23K 9/167

(52) U.S. Cl. CPC B23K 9/321; B23K 9/167

(57) ABSTRACT

The purpose of the TIG Glide is to stabilize the welder's torch hand/arm on the we ding surface with minimal friction to achieve the desired distance between the welding surface and the welding torch. The TIG Glide has minimal contacting surface area, allowing less heat transfer from part to hand/arm. Less heat transfer allows the welder to wear thin gloves versus thick gloves giving the welder more hand/arm maneuverability on bigger parts. This is fulfilled by the device's low friction embodiments, including/not limited to, caster wheels, ball transfers, sliding materials, etc., which are attached with securing devices to the TIC Glide base. The TIG Glide is then secured to the welder with the attachment apparatuses, wherein the welder attaches to, wears, or straps on his arm/hand/appendage a sliding device which glides along the welded piece or support and thus helps to stabilize hand/arm motion, lessen heat transfer, and improve precision.

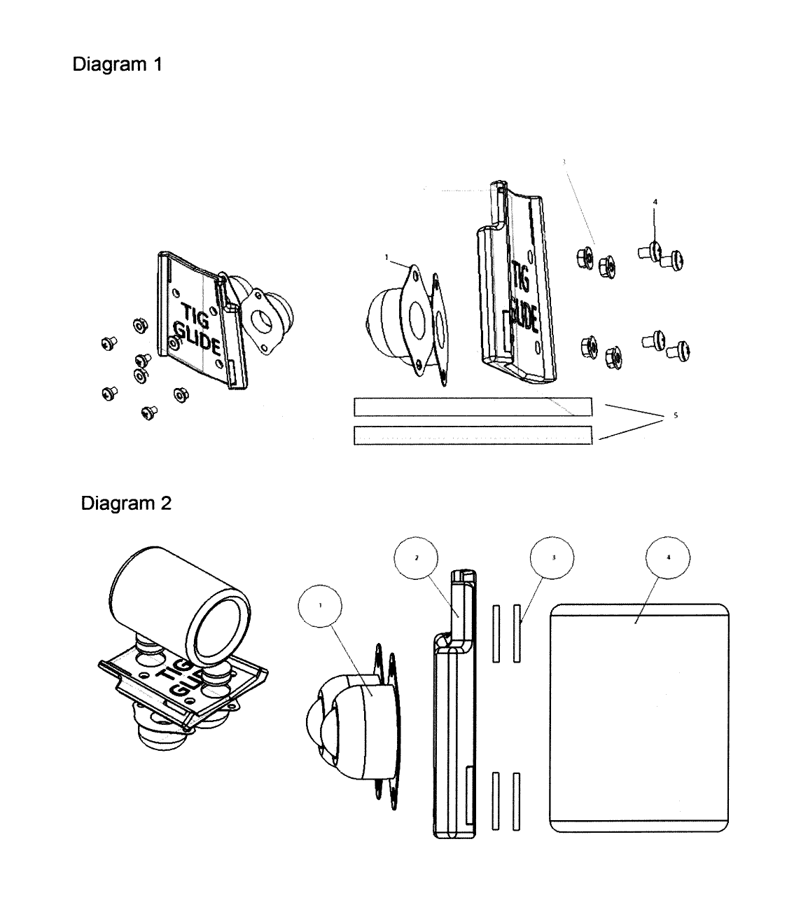

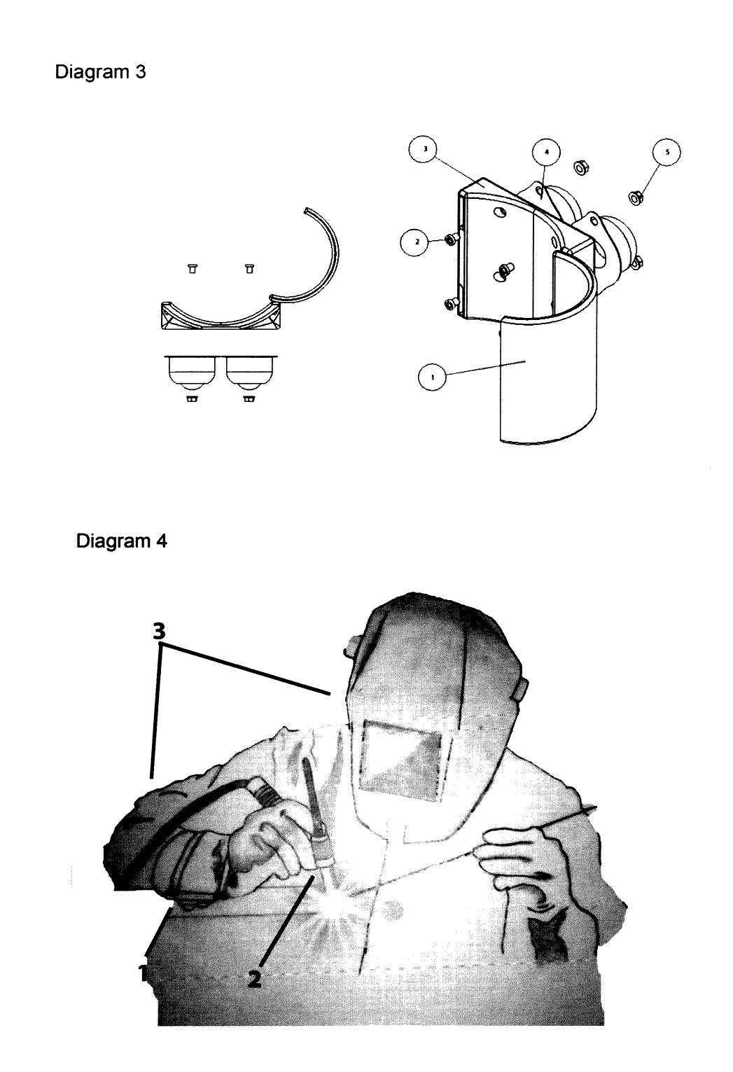

### FIELD OF THE INVENTION

The present invention is directed to a welder.

### DESCRIPTION OF THE RELATED ART

CN 203197439 U, Cutting stabilizer for a handheld cutting torch.

http://weldmongerstore.com/products/tig-finger, TIG finger.

http://jtillman.com/products/gloves/tig/, Tillman TIG gloves.

### SUMMARY

The problems that are solved by the TIG Glide include, but are not limited to; heat transference, glove snag, friction, hand/arm/torch stability, etc.

In order to solve the aforementioned problems, the TIG Glide stabilizes the welder's torch hand/arm, as well as minimizes the transfer of heat to the welder's hand/arm, as it easily glides along the work piece to aid the process of welding with a hand/arm stabilizer and relaxer, wherein the welder straps on, attaches to, or wears on, his arm/hand/appendage a sliding device which glides along the welded piece or support and thus helps to stabilize hand/arm motion and improve precision.

### BRIEF DESCRIPTION OF THE DRAWINGS

### Diagram 1

1. Labeled in diagram as 1). are the low friction device(s)

2. Labeled in diagram 1 as 2). is the device base

3. Labeled in diagram 1 as 3). are the fastening device(s)/material(s)

4. Labeled in diagram 1 as 4). are the fastening device(s)/material(s)

5. Labeled in diagram 1 as 5). are the attachment device(s)

### Diagram 2

1. Labeled in diagram 2 as 1). are the low friction device(s)

2. Labeled in diagram 2 as 2). is the device base

3. Labeled in diagram 2 as 3). are the fastening device(s)/material(s)

4. Labeled in diagram 2 as 4). is the attachment device(s)

### Diagram 3

1. Labeled in diagram 3 as 1). is the attachment device(s)

2. Labeled in diagram 3 as 2). are the fastening device(s)/material(s)

3. Labeled in diagram 3 as 3). is the device base

4. Labeled in diagram 3 as 4). are the low friction device(s)

5. Labeled in diagram 3 as 5). are the fastening device(s)/material(s)

### Diagram 4

1. Labeled in diagram 4 as 1). is the TIG Glide device

2. Labeled in diagram 4 as 2), is the welding torch

3. Labeled in diagram 4 as 3). is the welder

### DETAILED DESCRIPTION

The TIG Glide helps stabilize the torch hand on cylindrical, flat, and other welding surfaces. It makes it very easy to keep the desired distance between the welding surface and the end of the torch with minimal friction. The TIG Glide keeps close contact between the hand/arm and a welding piece with an embodiment of a hand/arm support connected to the low friction element such as caster wheel, ball transfer, etc. which freely slides on the welding piece. The TIG Glide has minimal contacting surface area, allowing much less heat transfer from part to hand. Less heat transfer allows the welder to wear thin gloves rather than thick gloves giving the welder more hand maneuverability on bigger parts.

1. The TIG Glide is a welding tool that consists of a platform with a securing device or devices resting on embodiments of low friction which include, but are not limited to; caster wheels, ball casters, sliding materials, or anything of that nature, with the purpose of stabilizing the welders torch hand as well as minimizing the transfer of heat to the welders hand as it easily glides along the work piece to aid the process of welding with a hand/arm stabilizer and relaxer, wherein the welder straps on, attaches to, wears on, or rests his arm/hand/appendage (on a) a sliding device which glides along the welded piece or support and thus helps to stabilize hand motion and improve precision.
